(19) United States
(12) Patent Application Publication
(10) Pub. No.: US 2015/0180040 A1
(43) Pub. Date: Jun. 25, 2015

(54) LEAD-ACID STORAGE BATTERY GRID AND LEAD-ACID STORAGE BATTERY

(71) Applicant: Panasonic Intellectual Property Management Co., Ltd., Osaka-shi, Osaka (JP)

(72) Inventors: Kohei Sano, Aichi (JP); Kenji Izumi, Shizuoka (JP); Kazuhiro Sugie, Shizuoka (JP); Etsuko Ogasawara, Aichi (JP); Misaki Harada, Aichi (JP); Yu Kojima, Shizuoka (JP)

(21) Appl. No.: 14/414,847

(22) PCT Filed: Oct. 8, 2013
(86) PCT No.: PCT/JP2013/005976

§ 371 Date: Jan. 14, 2015

(30) Foreign Application Priority Data
Dec. 3, 2012 (JP) 2012-264043
Apr. 5, 2013 (JP) 2013-079228

(51) Int. Cl. H01M 4/73; H01M 4/74

(52) U.S. Cl. CPC H01M 4/73; H01M 4/74; H01M 2220/20

(57) ABSTRACT

A lead-acid battery grid used for an electrode of a lead-acid battery, wherein the lead-acid battery grid is made of a Pb alloy containing at least one of Sn or Ca, and includes an upper frame constituting an upper side of the lead-acid battery grid, a lower frame constituting a lower side of the lead-acid battery grid, and a meshed part being present between the upper frame and the lower frame and including intersecting strands, a ratio Wu/W of a mass Wu of an upper half of the meshed part to a total mass W of the meshed part is 62.5% or higher and 67% or lower, and a cover layer containing a larger amount of Sn than the strands is formed on at least part of a surface of the strands, and the cover layer is not formed on a surface of the lower frame.

### TECHNICAL FIELD

The present disclosure relates to lead-acid battery grids, and lead-acid batteries using the lead-acid battery grids as positive electrode grids.

The present disclosure relates to lead-acid batteries used for vehicles with a start-stop system.

### BACKGROUND ART

### <Part 1>

A casting method which has been employed to form lead-acid battery grids used for electrodes of a lead-acid battery has been replacing with an expanding method providing a larger production quantity per unit time. The expanding method mainly includes a reciprocation method and a rotary method. According to the reciprocation method, a blade is pressed onto a sheet made of Pb or various types of Pb alloys along a longitudinal direction of the sheet to form slits, and simultaneously, the sheet is pressed downward to form a meshed part. In the rotary method, slits in a staggered pattern are formed in a sheet made of Pb or various types of Pb alloys along a longitudinal direction of the sheet, and then the sheet is stretched in a width direction of the sheet to form the meshed part.

Usually, a cell reaction actively occurs in an upper part of electrode plates in the lead-acid battery closer to collectors (tabs). In the case of the casting method, various contrivances have been made to improve current collection in an upper part of the grid. One advantageous technique for improving the current collection in the grid formed by the expanding method is relatively thickening strands constituting an upper part of the meshed part of the grid. However, strands constituting a lower part of the meshed part are relatively thin and relatively mechanically weakened, and are cracked to reduce life of the battery.

In view of these circumstances, Patent Document 1 describes that a lead-acid battery grid having good battery characteristics can be provided with high yields by optimizing a weight ratio of the upper part (an upper half) of the meshed part to an entire part of the meshed part (setting the weight ratio to 54% or higher and 62% or lower).

### <Part 2>

A vehicle with a start-stop system can reduce fuel consumption by shutting down an engine while the vehicle is stopped. Since the lead-acid battery supplies power consumed by an air conditioner and fans while the engine is shut down, charging of the lead-acid battery tends to be insufficient. Thus, the lead-acid battery is required to have high charge acceptability, i.e., to be able to be charged more in a short time, to avoid lack of charging. The vehicle with the start-stop system frequently shuts down and restarts the engine. Accordingly, next discharging is performed before lead sulfate generated by discharging recovers to lead dioxide and lead, and the life of the lead-acid battery easily decreases. Therefore, the lead-acid battery is required to have high durability to resolve the reduction in life.

For improved charge acceptability of the lead-acid battery, Patent Document 2 describes a lead-acid battery containing aluminum ions in an electrolytic solution. The aluminum ions are effective at reducing an increase in size of crystals of lead sulfate generated on the positive and negative electrodes during the discharging. This can improve the charge acceptability of the lead-acid battery.

For improved durability of the lead-acid battery, Patent Document 3 describes a lead-acid battery including negative electrode grids free from antimony, and a lead alloy layer containing antimony formed on each of the negative electrode grids. The lead alloy layer containing antimony is effective at efficiently recovering the negative electrode plates by the charging. This can improve the durability of the lead-acid battery.

Patent Document 4 describes a technique of adding sulfate of alkali metal, such as Na₂SO₄, to an electrolytic solution to reduce generation of lead ions due to a decrease in concentration of sulfuric acid when the battery is overdischarged, and to prevent the occurrence of a short circuit between the positive and negative electrodes caused by PbSO₄ grown on the negative electrodes while the battery is charged. Na₂SO₄ added to the electrolytic solution is effective at reducing a decrease in conductivity of the electrolytic solution associated with the decrease in concentration of sulfuric acid, and at improving recoverability of the battery from overdischarge.

### CITATION LIST

### Patent Documents

[Patent Document 1] Japanese Unexamined Patent Publication No. 2007-123105
[Patent Document 2] Japanese Unexamined Patent Publication No. 2006-4636
[Patent Document 3] Japanese Unexamined Patent Publication No. 2006-156371
[Patent Document 4] Japanese Unexamined Patent Publication No. H01-267965

### SUMMARY OF THE INVENTION

### Technical Problem

### <Part 1>

According to improvement in components of the lead-acid battery except for the grids, characteristics of the lead-acid battery (in particular, the life of the battery) have dramatically been improved. After the battery is repeatedly charged and discharged, the grid of the positive electrode plate (in particular, strands constituting the meshed part) is stretched to deform the positive electrode plate itself in a terminal stage of the battery life, and the positive electrode plate abuts a collector (a tab) of the negative electrode plate or a negative strap to cause an internal short circuit. Even if a user (e.g., a driver or an owner of the vehicle) wants to replace the lead-acid battery before this phenomenon occurs, the user cannot tell when to replace the lead-acid battery because predicting the phenomenon is very difficult.

To solve the above-described problem, the present disclosure provides a lead-acid battery grid which can provide a long-life lead-acid battery which allows a user to precisely tell when the battery needs replacing.

### <Part 2>

The lead-acid battery used for the vehicle with the start-stop system may easily fall short of charging. Thus, for preventing the overdischarge of the lead-acid battery, the vehicle with the start-stop system may be provided with a fail-safe mechanism which does not allow the lead-acid battery to discharge when a state of charge (SOC) of the battery is not higher than a predetermined value (e.g., 60%).

FIG. 4 is a graph schematically showing the state of charge (SOC) when the lead-acid battery in the vehicle with the start-stop system is discharged and charged repeatedly. Plots of FIG. 4 indicates a repetitive pattern in which reduction of the SOC as the lead-acid battery is discharged while the vehicle is stopped, and recovery of the SOC as the lead-acid battery is charged while the vehicle is driven are repeated.

If the lead-acid battery has high charge acceptability, the SOC of the lead-acid battery recovers to about 100% while the vehicle is driven. Thus, as indicated by a plot A in FIG. 4, the lead-acid battery can repeatedly be charged and discharged even when the vehicle with the start-stop system is driven for a long time.

When the charge acceptability of the lead-acid battery is not high, the lead-acid battery cannot sufficiently be charged while the vehicle is driven as indicated by a plot B in FIG. 4. When the vehicle is stopped before the SOC recovers to 100%, the SOC greatly decreases as the battery is discharged. When the battery is repeatedly charged and discharged in this way, the SOC gradually decreases. In this case, when the vehicle with the start-stop system is provided with the fail-safe mechanism, the fail-safe mechanism is actuated when the SOC is reduced to the predetermined value (e.g., 60%) or lower, and the battery stops discharging.

In particular, when the vehicle is driven to travel a short distance at a time (hereinafter may be referred to as a “short-distance drive”), the battery is not sufficiently charged while the vehicle is driven, and the SOC does not recover to 100%. Thus, the fail-safe mechanism is frequently actuated. When the vehicle is not used on weekdays, and is used for the “short-distance drive” on weekend, the SOC further decreases due to self-discharge and a dark current, and the fail-safe mechanism is actuated more frequently.

On the other hand, when the battery is not sufficiently charged (the SOC is low), the battery is required to show an output characteristic for restarting the engine once stopped by the start-stop system.

However, a lead-acid battery showing the charge acceptability and the output characteristic to a sufficient degree so that the battery can be applied to the vehicle with the start-stop system used in the “short-distance drive” mode has not been provided so far.

In view of the foregoing, the present disclosure has been achieved to provide a lead-acid battery which shows the charge acceptability and the output characteristic to a sufficient degree, and is applicable to the vehicle with the start-stop system used in the “short-distance drive” mode.

### Solution to the Problem

### <Part 1>

As a solution to the above-described problem, the present disclosure provides a lead acid-battery grid used for an electrode of a lead-acid battery, wherein the lead-acid battery grid is made of a Pb alloy containing at least one of Sn or Ca, and includes an upper frame constituting an upper side of the lead-acid battery grid, a lower frame constituting a lower side of the lead-acid battery grid, and a meshed part being present between the upper frame and the lower frame and including intersecting strands, a ratio Wu/W of a mass Wu of an upper half of the meshed part to a total mass W of the meshed part is 62.5% or higher and 67% or lower, and a cover layer containing a larger amount of Sn than the strands is formed on at least part of a surface of the strands, and the cover layer is not formed on a surface of the lower frame.

A mass ratio of Sn to the cover layer is preferably 0.2% or higher and 10.0% or lower.

The mass ratio of Sn to the cover layer is more preferably 3.0% or higher and 7.0% or lower.

The cover layer preferably further contains Sb, and a mass ratio of Sb to the cover layer is preferably 0.2% or higher and 10.0% or lower.

The mass ratio of Sb to the cover layer is more preferably 3.0% or higher and 7.0% or lower.

The lead-acid battery grid may be fabricated by an expanding method.

A lead-acid battery of the present disclosure uses the above-described lead-acid battery grid as a positive electrode grid.

### <Part 2>

A lead-acid battery of the present disclosure includes: electrode groups, each of which includes a plurality of positive electrode plates and a plurality of negative electrode plates stacked with separators interposed therebetween, and is contained in a cell chamber together with an electrolytic solution, wherein each of the positive electrode plates includes a positive electrode grid made of antimony-free lead or an antimony-free lead alloy, and a positive electrode active material filling the positive electrode grid, each of the negative electrode plates includes a negative electrode grid, and a negative electrode active material filling the negative electrode grid, the negative electrode grid includes a negative electrode grid body made of antimony-free lead or an antimony-free lead alloy, and a surface layer which is formed on a surface of the negative electrode grid body, and is made of a lead alloy containing antimony, and a mass ratio of an upper half of the positive electrode grid to a lower half of the positive electrode grid is 1.55 or higher and 2.0 or lower.

In a preferred embodiment, the electrolytic solution contains 0.03 mol/L or higher and 0.28 mol/L or lower of sodium ions.

In a preferred embodiment, the negative electrode plates are contained in the separators, each of which is bag-shaped, and are arranged on sides of the electrode group.

### Advantages of the Invention

### <Part 1>

The present disclosure can provide a lead-acid battery grid capable of providing a long-life, highly productive lead-acid battery which allows a user to precisely tell when the battery needs replacing.

### <Part 2>

The present disclosure can provide a lead-acid battery which shows the charge acceptability and the output characteristic to a sufficient degree, and is applicable to the vehicle with the start-stop system used in the “short-distance drive” mode.

### BRIEF DESCRIPTION OF THE DRAWINGS

FIG. 1 is a view showing a lead-acid battery grid.

FIG. 2 is a view showing a lead-acid battery.

FIG. 3 is a schematic view showing an example of a method for manufacturing the lead-acid battery grid.

FIG. 4 is a graph showing a state of charge (SOC) of the lead-acid battery which is mounted on a vehicle with a start-stop system, and repeatedly charged and discharged.

FIG. 5 is an overview diagram showing a structure of a lead-acid battery of an embodiment of the present disclosure.

### DESCRIPTION OF EMBODIMENTS

### <Part 1>

Embodiments of the present disclosure will be described below with reference to the drawings.

### First Embodiment

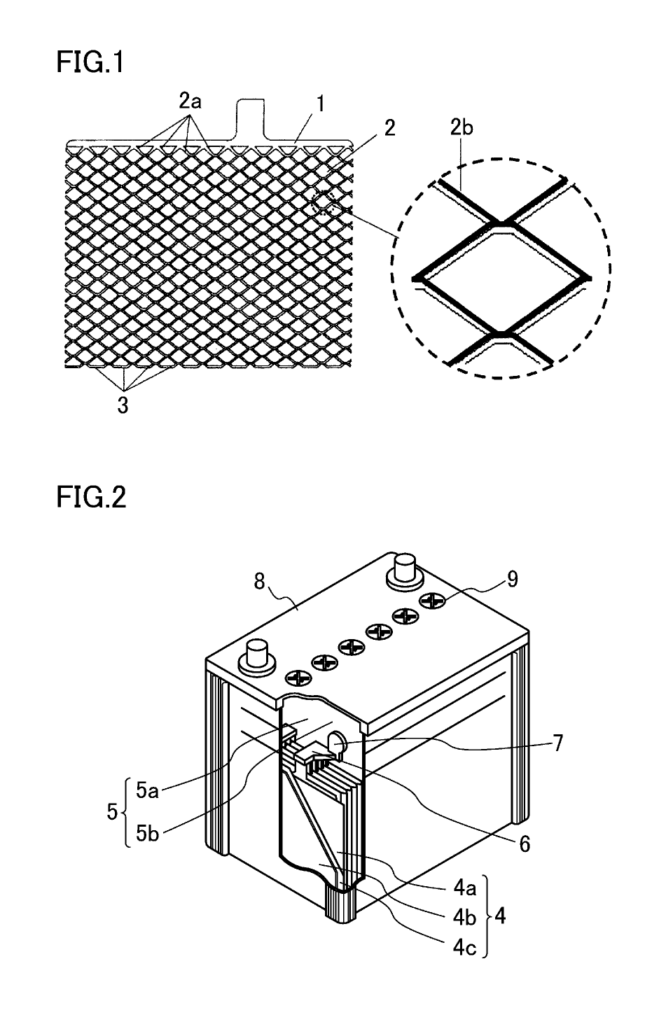

FIG. 1 shows a lead-acid battery grid. The lead-acid battery grid is substantially quadrangular, and includes an upper frame 1 constituting an upper side frame of the grid, a lower frame 3 constituting a lower side frame of the grid, and a meshed part 2 present between the upper frame 1 and the lower frame 3 and includes intersecting strands 2a. The upper frame 1, the meshed part 2, and the lower frame 3 are made of a Pb alloy containing at least one of Sn or Ca.

The lead-acid battery grid of the first embodiment has two features. A first feature is that a ratio Wu/W of a mass Wu of an upper half of the meshed part 2 relative to a total mass W of the meshed part 2 is 62.5% or higher and 67% or lower. A second feature is that a cover layer 2b richer in Sn than the strands 2a is formed on at least part of a surface of the strands 2a, and the cover layer 2b is not formed on the lower frame 3.

Patent Document 1 describes that a lead-acid battery using a grid having the mass ratio Wu/W higher than 62% as a positive electrode grid is short-life due to cracking of the strands 2a. However, when the lead-acid battery includes a grid in which the cover layer 2b richer in Sn than the strands 2a is formed on the surface of the strands 2a, and the cover layer 2b is not formed on the lower frame 3 as the positive electrode grid, the cracking of the strands 2a concerned by Patent Document 1 is less likely to occur, and the lead-acid battery shows an excellent life characteristic. A possible reason for the improved life characteristic is that the cover layer containing a proper amount of Sn enhances the mechanical strength of the strands.

When a grid in which the mass ratio Wu/W is 62.5% or higher (a mass ratio of a lower half of the meshed part is 37.5% or lower) is used at least in the positive electrode plate, the lower half of the strands 2a is selectively corroded. Then, a stretch of the strands 2a in a terminal stage of the battery life is canceled by loss of the strands 2a due to the corrosion of the lower half of the meshed part 2. As a result, the internal short circuit, which occurs when the electrode plate is deformed by the stretched strands 2a which cannot go anywhere, is less likely to occur. Thus, the lead-acid battery does not suddenly stop the operation, and a capacity of the battery clearly decreases in proportional to the loss of the strands 2a. Accordingly, the user can precisely tell when the lead-acid battery needs replacing in the terminal stage of the battery life.

When a grid in which the ratio Wu/W exceeds 67% is used as the positive electrode grid, an amount of an active material filling the grid may significantly vary between an upper part and a lower part of the grid. When the positive electrode grid in which the amount of the active material significantly varies is used in the lead-acid battery, quality of the battery may decrease due to variations in initial characteristics.

The ratio of a mass of Sn to the cover layer 2b is preferably 0.2% or higher and 10.0% or lower, and more preferably 3.0% or higher and 7.0% or lower. The grid improves in mechanical strength when the ratio of the mass of Sn to the cover layer 2b is 0.2% or higher, and the grid improves in resistance to corrosion and in life characteristic when the ratio is 10.0% or lower.

The cover layer 2b may further contain Sb, and a ratio of a mass of Sb is preferably 0.2% or higher and 10.0% or lower, more preferably 3.0% or higher and 7.0% or lower. The life characteristic improves when the ratio of the mass of Sb to the cover layer 2b is 0.2% or higher. However, the ratio of the mass of Sb of 10.0% or higher is not preferable because a decrease of the electrolytic solution through the repeated charge and discharge increases.

Generally, the cover layer 2b can contain Pb, Sn, Sb, and Ag.

FIG. 2 shows the lead-acid battery. The grids of the first embodiment are used in at least positive electrode plates 4a. The positive electrode plates 4a and negative electrode plates 4b are alternately arranged with separators 4c interposed therebetween to form an electrode group 4. Then, a plurality of electrode groups 4 are contained in cell chambers 5b divided by dividers 5a in a battery box 5, respectively. In each of the electrode groups 4, a plurality of tabs of the positive electrode plates 4a are connected to a strap 6, and a plurality of tabs of the negative electrode plates 4b are connected to another strap 6. Then, the straps 6 having opposite polarities in adjacent electrode groups 4 are connected to a connector 7 penetrating the divider 5a. Then, an opening of the battery box 5 is covered with a lid 8 having a liquid port. Dilute sulfuric acid as an electrolytic solution is poured in the battery box through the liquid port, and the liquid port is sealed with a plug 9. Finally, an initial charge is performed under the predetermined conditions to obtain the lead-acid battery.

An active material of the positive electrode plate 4a may be lead suboxide powder optionally containing minium, etc. An active material of the negative electrode plate 4b may be the lead suboxide powder described above optionally containing barium sulfate, a lignin compound, etc. The separator 4c may be made of polyethylene, polypropylene, polyethylene terephthalate, glass fibers, etc.

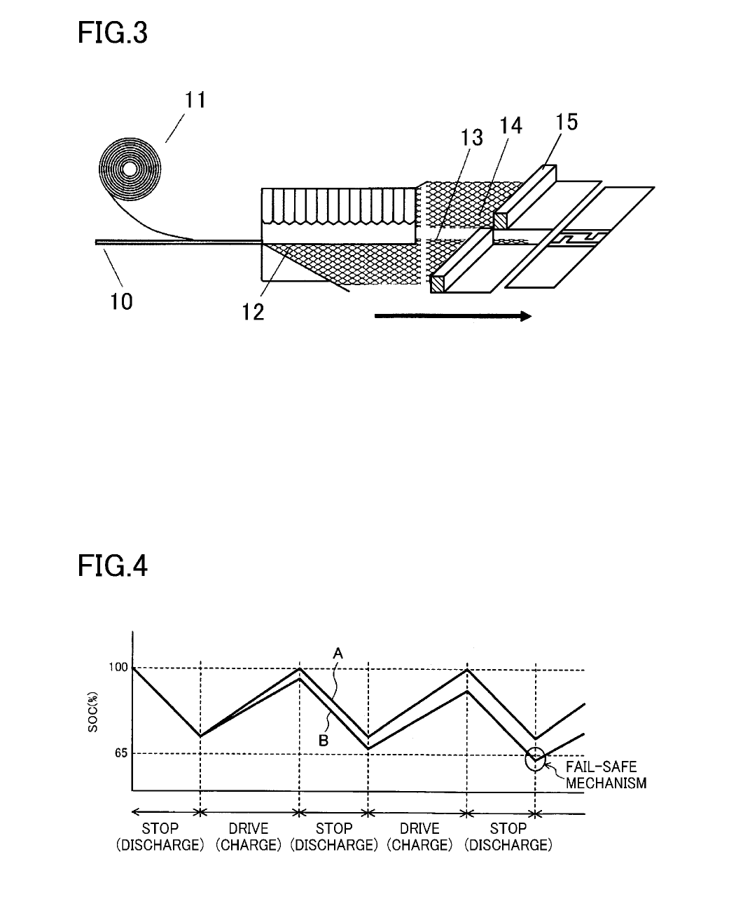

FIG. 3 is a schematic view showing an example of a method for manufacturing the lead-acid battery grid of the first embodiment (a reciprocation method). To at least one of surfaces of a sheet 10 made of a Pb alloy containing at least one of Sn or Ca, foil 11 richer in Sn than the sheet 10 is bonded (the foil essentially contains Pb and Sn, and may contain Sb and Ag). Then, a blade is pressed onto the sheet along a longitudinal direction of the sheet 10 to form slits 12, and simultaneously, the sheet is pressed downward to form a continuous body 14 having a meshed part 2 including intersecting strands 2a, and a plain part 13 in which the meshed part 2 is not formed.

Then, active material paste 15 is successively supplied to fill the continuous body 14. The continuous body 14 filled with the active material paste 15 is cut into a predetermined dimension to provide the positive electrode plate 4a or the negative electrode plate 4b.

The manufacturing method described above has two cautions. A first caution is that a ratio Wu/W of a mass Wu of an upper half of the meshed part 2 (a half of the meshed part closer to the upper frame 1) to a total mass W of the meshed part 2 is controlled to 62.5% or higher and 67% or lower by forming the slits 12 at greater intervals in part of the sheet corresponding to the upper half of the meshed part 2 than in part of the sheet corresponding to a lower half to make the strands thicker. A second caution is that the foil 11 is not bonded to part of the sheet corresponding to the lower frame 3 so that the cover layer 2b is not formed on the lower frame 3.

In the grid formed by this method, the strands 2a have a quadrangular cross section, and the cover layer 2b is formed on one of sides of the quadrangle.

Advantages of the present disclosure will be described below by way of examples.

### EXAMPLES

### Battery A

Foil 11 made of Pb containing 5% by mass of Sn and 5% by mass of Sb (processed later to be a cover layer 2b) was bonded to a surface of a sheet 10 made of Pb containing 1.3% by mass of Sn and 0.06% by mass of Ca. The foil 11 was not bonded to part of the sheet to be a lower frame 3 in a later process.

Then, a blade was pressed onto the sheet along a longitudinal direction of the sheet 10 to form slits 12 at greater intervals in part of the sheet 10 corresponding to an upper half of the meshed part 2 than in part of the sheet corresponding to a lower half thereof, and simultaneously, the sheet was pressed downward. Thus, a continuous body 14 including the meshed part 2 in which strands 2a were intersecting, and a plain part 13 in which the meshed part 2 was not formed was fabricated (a ratio Wu/W of a mass Wu of the upper half of the meshed part 2 to a total mass W of the meshed part 2 was 62%).

Then, positive electrode active material paste (active material paste 15) prepared by kneading lead oxide powder with sulfuric acid and purified water was successively supplied to fill the continuous body 14, and the continuous body 14 was cut into a predetermined dimension to form a positive electrode plate 4a.

A negative electrode plate 4b was then formed in the similar manner for forming the positive electrode plate 4a except that the sheet 10 had a different composition (made of Pb containing 0.3% by mass of Sn and 0.06% by mass of Ca), the cover layer 2b was not formed, the slits 12 were formed at fixed intervals, and the active material paste 15 had a different composition (negative electrode active material paste was made by kneading lead oxide powder to which an organic additive, barium sulfate, carbon, etc. were added by a conventional method with sulfuric acid and purified water).

Seven positive electrode plates 4a and eight negative electrode plates 4b were alternately arranged with polyethylene separators 4c interposed therebetween to provide an electrode plate group 4. Six electrode groups 4 were contained in cell chambers 5b one by one. In each of the electrode groups, tabs of the positive electrode plates 4a were connected to a strap 6, and tabs of the negative electrode plates 4b were connected to another strap 6. The straps 6 having opposite polarities in adjacent electrode groups 4 were connected to a connector 7 penetrating a divider 5a. Then, an opening of a battery box 5 was covered with a lid 8 having a liquid port. An electrolytic solution (dilute sulfuric acid) was poured in the battery box through the liquid port, and the liquid port was sealed with a plug 9. An initial charge was then performed to fabricate a 12V, 55 Ah lead-acid battery (Battery A).

### Batteries B, C, D, E, F, and G)

Batteries B, C, D, E, F, and G were fabricated in the same manner as Battery A except that the intervals between the slits 12 in the upper half of the meshed part 2 and the intervals between the slits 12 in the lower half of the meshed part 2 were adjusted to vary the ratio Wu/W as shown in Table 1.

### (Batteries H and I)

Battery H was fabricated in the same manner as Battery D except that the cover layer 2b was formed also on the lower frame 3. Further, Battery I was fabricated in the same manner as Battery D except that the cover layer 2b was not formed at all.

### (Batteries J, K, L, M, N, O, and P)

Batteries J, K, L, M, N, O, and P were fabricated in the same manner as Battery D except that the mass ratio of Sn to the cover layer 2b was varied as shown in Table 1.

### (Batteries Q, R, S, T, U, V, and W)

Batteries Q, R, S, T, U, V, and W were fabricated in the same manner as Battery D except that the mass ratio of Sb to the cover layer 2b was varied as shown in Table 1.

Batteries A-W were evaluated as follows. Table 1 shows the results.

### (Life Test)

Batteries kept at 75° C.±3° C. were continuously discharged at a rated cold cranking current for 5 seconds, and a voltage measured after the 5-second discharge was recorded. After the initial value was checked, the batteries kept at 75° C.±3° C. were repeatedly charged and discharged at a discharge current of 25.0 A±0.1 A (discharge time: 120±1 seconds), a charge voltage of 14.80V±0.03V, a controlled current of 25.0 A±0.1 A (charge time: 600±1 seconds). Then, a voltage measured after the 5-second discharge at the cold cranking current was recorded every 480 cycles in the same manner as the measurement of the initial value. When the voltage after 5 seconds was not higher than 7.2V, and was not increased any more, it was regarded that the battery life ended, and the test was finished. A value obtained by subtracting the voltage after 5 seconds in the cycle in which the battery life ended from the voltage after 5 seconds measured last time (in a cycle preceding the cycle in which the battery life ended by 480 cycles) was converted as an index with respect to the value of Battery A regarded as 100. The index is shown in Table 1 together with a cycle number at which the battery life ended.

### (Variations in Initial Characteristic)

Batteries A-W, 30 pieces each, were prepared, and the voltage was measured after the 5-second discharge at the cold cranking current in the same manner as the above-described life test. Statistics of the voltages after 5 seconds of the 30 batteries were taken, and standard deviation 6 obtained is shown in Table 1.

### (Mechanical Strength of Grid)

After the continuous body 14 was formed from the sheet 10, and before the positive electrode active material paste was successively fed to fill the continuous body 14, the continuous body was cut by 10 m to visually observe the meshed part 2. A ratio of torn or broken strands 2a relative to a total number of the strands 2a (part between intersections is counted as 1 strand) is shown in Table 1 as a standard of the mechanical strength of the grid.

### (Decrease of Electrolytic Solution)

In the above-described life test, a weight of each battery was measured every 480 cycles so that a decrease in weight relative to an initial weight was regarded as a decrease of the electrolytic solution. For precluding the influence of sudden decrease of the electrolytic solution due to an internal short circuit, the decrease of the electrolytic solution measured last time (in a cycle preceding the cycle in which the battery life ended by 480 cycles) was divided by the cycle number (the cycle number at which the battery life ended-480), and the obtained value was shown in Table 1 as a standard of the decrease of the electrolytic solution.

TABLE 1

| | | | | | | Evaluation results | | | | |
|---|---|---|---|---|---|---|---|---|---|---|
| | | | | | | | Difference between a voltage | | | |
| | | | | | | | after 5 sec in a cycle | | | |
| | | | | | | Cycle | in which battery life ended and | | | |
| | | Cover layer 2b | | | | number at | a voltage after 5 sec in a cycle | Variations | Breakage | Decrease of |
| | | | | Sn | Sb | which | preceding the cycle in which | in voltage | rate of | electrolytic |
| | Wu/W | On meshed | On lower | (% by | (% by | battery life | battery life ended by 480 cycles | after 5 sec | strand | solution |
| Battery | (%) | part 2 | frame 3 | mass) | mass) | ended | (regarding Battery A as 100) | σ (%) | (%) | (g/cycle) |
| A | 62 | present | Not present | 5 | 5 | 3840 | 100 | 0.3 | 0 | 0.3 |
| B | 62.5 | present | Not present | 5 | 5 | 4320 | 43 | 0.3 | 0 | 0.3 |
| C | 64 | present | Not present | 5 | 5 | 4800 | 19 | 0.3 | 0 | 0.3 |
| D | 65 | present | Not present | 5 | 5 | 4800 | 10 | 0.3 | 0 | 0.3 |
| E | 66 | present | Not present | 5 | 5 | 4800 | 10 | 0.9 | 0 | 0.3 |
| F | 67 | present | Not present | 5 | 5 | 4800 | 10 | 1.5 | 0 | 0.3 |
| G | 68 | present | Not present | 5 | 5 | 4800 | 10 | 5.3 | 0 | 0.3 |
| H | 65 | present | present | 5 | 5 | 2880 | 10 | 0.3 | 1.9 | 0.3 |
| I | 65 | Not present | Not present | — | — | 2880 | 10 | 0.3 | 1.8 | 0.2 |
| J | 65 | present | Not present | 0.1 | 5 | 3840 | 10 | 0.3 | 0.48 | 0.3 |
| K | 65 | present | Not present | 0.2 | 5 | 4320 | 10 | 0.3 | 0.09 | 0.3 |
| L | 65 | present | Not present | 1 | 5 | 4800 | 10 | 0.3 | 0.03 | 0.3 |
| M | 65 | present | Not present | 3 | 5 | 4800 | 10 | 0.3 | 0 | 0.3 |
| N | 65 | present | Not present | 7 | 5 | 4800 | 10 | 0.3 | 0 | 0.3 |
| O | 65 | present | Not present | 10 | 5 | 4320 | 10 | 0.3 | 0 | 0.3 |
| P | 65 | present | Not present | 12 | 5 | 3840 | 10 | 0.3 | 0 | 0.3 |
| Q | 65 | present | Not present | 5 | 0.1 | 3840 | 10 | 0.3 | 0 | 0.2 |
| R | 65 | present | Not present | 5 | 0.2 | 4320 | 10 | 0.3 | 0 | 0.2 |
| S | 65 | present | Not present | 5 | 1 | 4320 | 10 | 0.3 | 0 | 0.2 |
| T | 65 | present | Not present | 5 | 3 | 4800 | 10 | 0.3 | 0 | 0.2 |
| U | 65 | present | Not present | 5 | 7 | 4800 | 10 | 0.3 | 0 | 0.4 |
| V | 65 | present | Not present | 5 | 10 | 5280 | 10 | 0.3 | 0 | 0.6 |
| W | 65 | present | Not present | 5 | 12 | 5280 | 10 | 0.3 | 0 | 0.9 |

Batteries A-G are compared. The cycle number at which Battery A having the ratio Wu/W lower than 62.5% reached the end of the life was not significantly small, but the difference between the voltage after 5 seconds in the cycle in which the battery life ended and the voltage after 5 seconds in the cycle preceding the former cycle by 480 cycles was great. The great difference suggests that the discharge capacity suddenly dropped due to the internal short circuit. When Battery A was disassembled after the life test, the upper part of the strands 2a constituting the meshed part 2 of the positive electrode plate 4a was considerably deformed and abutted the adjacent negative electrode plate 4b.

Batteries B-G (in particular, Batteries C-G) having the ratio Wu/W not lower than 62.5% did not show the sudden drop of the discharge capacity as shown by Battery A. However, Battery G having the ratio Wu/W higher than 67% showed significant variations in initial characteristic. The significant variations in initial characteristic are not preferable because stable lead-acid batteries cannot be supplied to customers.

The results indicate that the ratio Wu/W should be controlled to 62.5% or higher and 67% or lower as the ratios in Batteries B-F (preferably, 64% or higher and 66% or lower as the ratios in Batteries C-E) to avoid the sudden drop of the discharge capacity due to the internal short circuit, and to reduce the variations in initial characteristic through the repeated charge and discharge.

Batteries D, H, and I are compared. Even when the ratio Wu/W was in the optimum range, Battery H in which the cover layer 2b was formed also on the lower frame 3 showed poor life characteristic. Battery I in which the cover layer 2b was not formed showed poor mechanical strength of the grid of the positive electrode plate 4a.

Battery D is compared with Batteries J-P. The mechanical strength of the grid of the positive electrode plate 4a was slightly lowered when the mass ratio of Sn to the cover layer 2b was lower than 0.2%, and the life characteristic was slightly lowered when the mass ratio exceeded 10.0%. This indicates that the mass ratio of Sn to the cover layer 2b is preferably 0.2% or higher and 10.0% or lower, more preferably 3.0% or higher and 7.0% or lower.

Battery D is compared with Batteries Q-W. The life characteristic was slightly lowered when the mass ratio of Sb to the cover layer 2b was lower than 0.2%, and the decrease of the electrolytic solution increased when the mass ratio exceeded 10.0%. This indicates that the mass ratio Sb to the cover layer 2b is preferably 0.2% or higher and 10.0% or lower, more preferably 3.0% or higher and 7.0% or lower.

### <Part 2>

An embodiment of the present disclosure will be described below with reference to the drawings. The present disclosure is not limited to the following embodiment. The following embodiment can suitably be modified without deviating the scope of the present disclosure, and can be combined with other embodiments.

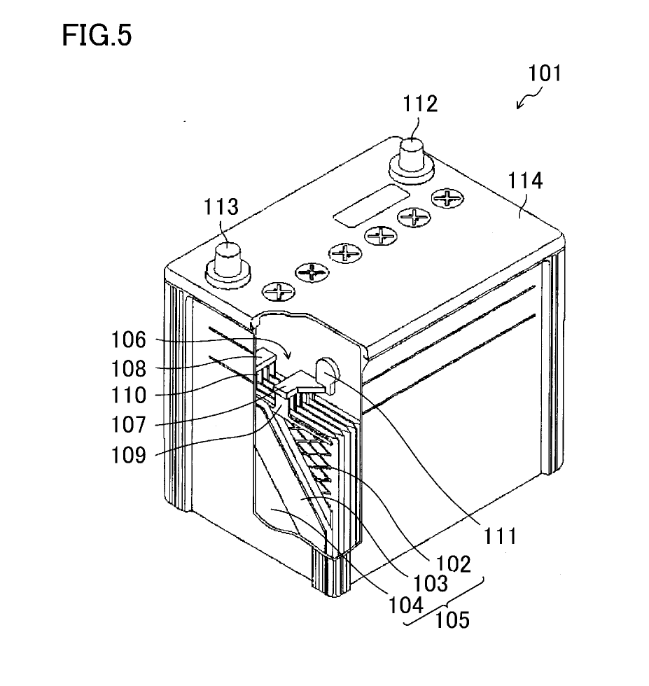

FIG. 5 is an overview diagram schematically showing the structure of a lead-acid battery 101 of an embodiment of the present disclosure.

As shown in FIG. 5, the lead-acid battery 101 includes a plurality of electrode groups 105, each of which includes a plurality of positive electrode plates 102 and a plurality of negative electrode plates 103 stacked with separators 104 interposed therebetween, and is contained in a cell chamber 106 together with an electrolytic solution.

Each of the positive electrode plates 102 includes a positive electrode grid, and a positive electrode active material filling the positive electrode grid. Each of the negative electrode plates 103 includes a negative electrode grid, and a negative electrode active material filling the negative electrode grid. The positive electrode grid of the present embodiment is made of antimony (Sb)-free lead or an antimony-free lead alloy, e.g., a Pb—Ca alloy, a Pb—Sn alloy, or a Pb—Sn—Ca alloy.

The plurality of positive electrode plates 102 are connected in parallel by connecting tabs 109 of the positive electrode grids to a positive electrode strap 107. The plurality of negative electrode plates 103 are connected in parallel by connecting tabs 110 of the negative electrode grids to a negative electrode strap 108. The electrode groups 105 contained in the cell chambers 106 are connected in series by a connector 111. Poles (not shown) are welded to the positive electrode strap 107 and the negative electrode strap 108 in each of the outermost cell chambers 106. The poles are welded to a positive electrode terminal 112 and a negative electrode terminal 113 arranged on a lid 114, respectively.

In the present embodiment, the negative electrode grid is provided by forming a surface layer (not shown) made of a lead alloy containing antimony on a surface of a negative electrode grid body made of antimony (Sb)-free lead or an antimony-free lead alloy. The lead alloy containing antimony can reduce hydrogen overvoltage, thereby improving charge acceptability of the lead-acid battery 101. The surface layer is preferably made of a Pb—Sb based alloy containing 1.0% by mass or higher and 5.0% by mass or lower of antimony. The negative electrode grid body may be made of a Pb—Ca alloy, a Pb—Sn alloy, or a Pb—Sn—Ca alloy, for example.

In the present embodiment, a mass ratio of an upper half of the positive electrode grid to a lower half of the positive electrode grid is 1.55 or higher and 2.0 or lower. Setting the mass ratio to 1.55 or higher brings a sufficient output characteristic for restarting the stopped engine in a state where the battery is not sufficiently charged (when SOC is low). Further, setting the mass ratio to 2.0 or lower can prevent a decrease in yield due to break of the strands of the grid during its manufacture by the expanding method. In this context, the “upper half” and the “lower half” of the positive electrode grid are defined relative to an entire region of the positive electrode grid including its frame and excluding the tabs 109.

In the present embodiment, the negative electrode plates 103 are preferably arranged on both sides of the electrode group 105, and the negative electrode plates 103 are contained in the separators 104, each of which is bag-shaped. Thus, the electrolytic solution can sufficiently penetrate the negative electrode plates 103 arranged on both sides of the electrode group 105, and the charge acceptability of the lead-acid battery 101 is further improved. When the lead-acid battery of the present embodiment is applied to a vehicle with a start-stop system used in a “short-distance drive” mode, actuation of the fail-safe mechanism can effectively be restrained.

In the present embodiment, the electrolytic solution preferably contains 0.03 mol/L or higher and 0.28 mol/L or lower of sodium ions. The sodium ions in the electrolytic solution are effective at improving recoverability of the battery from overdischarge. Thus, even when the vehicle is used in the “short-distance drive” mode, and the lead-acid battery recovered from the overdischarge is repeatedly charged and discharged, reduction in SOC due to the discharge can be reduced, thereby restraining the actuation of the fail-safe mechanism.

The structure and advantages of the present disclosure will be described in further detail by way of examples. The present disclosure is not limited to the examples.

### (1) Fabrication of Lead-Acid Battery

A lead-acid battery 101 fabricated in this example was a liquid-type D23L lead-acid battery adhered to JIS D5301. Cell chambers 106 contained sets of 7 positive electrode plates 102 and 8 negative electrode plates 103, respectively, and each of the negative electrode plates 103 was contained in a bag-shaped polyethylene separator 104.

The positive electrode plate 102 was fabricated by filling an expanded grid made of a calcium-based lead alloy with a paste prepared by kneading lead oxide powder with sulfuric acid and purified water. The expanded grid is formed by a reciprocation method, i.e., by expanding a sheet made of a calcium-based lead alloy while providing slits at predetermined intervals in the sheet. The intervals between the slits were made smaller in part of the sheet corresponding to an upper half of the grid closer to the tabs 109 than in part of the sheet corresponding to a lower half of the expanded grid to obtain the expanded grid in which a mass ratio of the upper half to the lower half was increased. The mass ratio of the upper half of the expanded grid to the lower half thereof can be controlled to a required value by adjusting the degree of change in intervals between the slits.

The negative electrode plate 103 was formed by filling an expanded grid made of a calcium-based lead alloy (a negative electrode grid body) with a paste prepared by kneading lead oxide powder added with an organic additive, etc. with sulfuric acid and purified water. As described below, a surface layer was formed on a surface of the negative electrode grid body in some examples.

The obtained positive and negative electrode plates 102 and 103 were aged and dried. Then, the negative electrode plates 103 were contained in the bag-shaped polyethylene separators 104, respectively, and were alternately stacked with the positive electrode plates 102. Thus, an electrode group 105 including 7 positive electrode plates 102 and 8 negative electrode plates 103 stacked with the separators 104 interposed therebetween was formed. Six electrode groups 105 were contained in 6 cell chambers 106, respectively, and were connected in series. Thus, the lead-acid battery 101 was fabricated.

An electrolytic solution made of dilute sulfuric acid having a density of 1.28 g/cm³ was poured in the lead-acid battery 101, and a battery box was formed to obtain a 12V, 48 Ah lead-acid battery 101.

### (2) Evaluation of Lead-Acid Battery

### (2-1) Evaluation of Characteristic in “Short-Distance Drive” Mode

The obtained lead-acid battery 101 was repeatedly charged and discharged to simulate the “short-distance drive” mode to evaluate the characteristic of the lead-acid battery in the “short-distance drive” mode. An environmental temperature was 25° C.±2° C.
(A) Discharge the battery at 9.6 A for 2.5 hours, and leave the battery for 24 hours.
(B) Discharge the battery at a discharge current of 20 A for 40 seconds.
(C) Charge the battery at a charge voltage of 14.2 V (at a controlled current of 50 A) for 60 seconds.
(D) Repeat a cycle including steps (B) and (C) 18 times, and then discharge the battery at a discharge current of 20 mA for 83.5 hours.
(E) Repeat a cycle including steps (B)-(D) 20 times.

A state of charge (SOC) of the lead-acid battery after the 20 cycles was measured, and the measured value was regarded as the characteristic in the “short-distance drive” mode.

(2-2) Recoverability from Overdischarge

The obtained lead-acid battery 101 was repeatedly charged and discharged in the following manner on the assumption that the lead-acid battery 101 recovered from the overdischarge was used again in the “short-distance drive” mode to evaluate recoverability of the battery.

(A) Discharge the battery at a 5 hour rate current (a discharge current of 9.8 A) to 10.5 V.

(B) Discharge the battery under a load of 10 W at a temperature of 40° C.±2° C. for 14 days, and leave the battery for 14 days in an open circuit state.

(C) Charge the battery at a charge voltage of 15.0V (at a controlled current of 25 A) at a temperature of 25° C.±3° C. for 4 hours.

(D) Leave the battery in atmospheric air at −15° C.±1° C. for 16 hours, and discharge the battery at 300 A to 6.0 V.

A duration for which the voltage of the lead-acid battery reached 6.0 V was evaluated as the recoverability from the overdischarge.

### (2-3) Output Characteristic in Low SOC

The fabricated lead-acid battery 101 was tested in the following manner on the assumption that the SOC of the lead-acid battery 101 was lowered due to lack of charging after repeated “short-distance drive,” and the engine was restarted in severe environment (at a low temperature) after the vehicle was stopped.

A) Bring the battery to full charge in an environment at 25° C.±1° C. by a method adhered to JIS D5301 “9.4.2 Charging,” “a) Charging at Constant Current,” and discharge the battery at 5 hour rate current (9.6 A) for 0.5 hours to adjust the SOC to 90%.

(B) Leave the battery in an environment at −15° C.±1° C. for 16 hours, and discharge the battery at 300 A to 6.0 V.

A discharge voltage measured after 5 seconds from the start of the discharge (B) was evaluated as an output characteristic in low SOC.

### (2-4) Defect Ratio of Positive Electrode Plate 102

Expanded grids formed by the reciprocation method were filled with paste to form positive electrode plates 102, and visual inspection was performed to check whether the expanded grid was broken or not in the formation (whether the strands constituting the substantially diamond-shaped grid were broken, or extremely deformed and nearly broken). A ratio of the number of defective positive electrode plates 2 to a total number of the formed positive electrode plates 2 (defect ratio) was evaluated as an index of easy break of the strands.

### Example 1

A surface layer made of a lead alloy containing antimony was formed on a surface of a negative electrode grid, and a mass ratio of an upper half of a positive electrode grid to a lower half of the positive electrode grid was varied in a range of 1.5-2.2 to fabricate Batteries 1-7. The characteristic in the “short-distance drive” mode, the output characteristic in low SOC, and a yield of the positive electrode plate 102 were evaluated on each of the fabricated batteries. Negative electrode plates were arranged on both sides of an electrode group, and were contained in bag-shaped separators.

The negative electrode grid was an expanded grid including a negative electrode grid body made of an expanded grid of Pb-1.2Sn-0.1Ca, and the surface layer was made of Pb foil containing 3% by mass of Sb. The positive electrode grid was an expanded grid made of Pb-1.6Sn-0.1Ca, and did not include any surface layer. To an electrolytic solution, 0.11 mol/L of sodium sulfate (Na₂SO₄) was added.

Table 2 shows the results of evaluation of the characteristics. As comparative examples, Battery 8 in which the surface layer was not formed on the surface of the negative electrode grid, and Battery 9 in which the positive electrode plate was contained in the bag-shaped separator in place of the negative electrode plate were fabricated.

TABLE 2

| | | | | | | | | | “Short- | | | Duration |
|---|---|---|---|---|---|---|---|---|---|---|---|---|
| | | Positive electrode plate | | | | | | | distance | | | indicating |
| | | Positive electrode grid | | | | | | | ride” | | Defect | recover- |
| | | | Mass ratio | | Negative | | | | charac- | Output | ratio of | ability |
| | Na ion | | of upper | | electrode plate | | | | teristic | characteristic | positive | from over- |
| | content | | half/lower | Surface | | Surface | Separator | | SOC | in low SOC | electrode | discharge |
| | (mol/L) | Composition | half | layer | Composition | layer | Shape | Contains | (%) | (V) | plate (%) | (min) |
| Battery 1 | 0.11 | Pb—Sn—Ca | 1.5 | Not | Pb—Sn—Ca | Pb—Sb | Bag | Negative | 72 | 8.0 | 0 | 3.0 |
| | | | | present | | | | electrode | | | | |
| | | | | | | | | plate | | | | |
| Battery 2 | 0.11 | Pb—Sn—Ca | 1.55 | Not | Pb—Sn—Ca | Pb—Sb | Bag | Negative | 73 | 8.7 | 0 | 3.0 |
| | | | | present | | | | electrode | | | | |
| | | | | | | | | plate | | | | |
| Battery 3 | 0.11 | Pb—Sn—Ca | 1.6 | Not | Pb—Sn—Ca | Pb—Sb | Bag | Negative | 74 | 8.8 | 0 | 3.0 |
| | | | | present | | | | electrode | | | | |
| | | | | | | | | plate | | | | |
| Battery 4 | 0.11 | Pb—Sn—Ca | 1.7 | Not | Pb—Sn—Ca | Pb—Sb | Bag | Negative | 75 | 8.9 | 0 | 3.0 |
| | | | | present | | | | electrode | | | | |
| | | | | | | | | plate | | | | |
| Battery 5 | 0.11 | Pb—Sn—Ca | 1.8 | Not | Pb—Sn—Ca | Pb—Sb | Bag | Negative | 75 | 9.1 | 0.05 | 3.0 |
| | | | | present | | | | electrode | | | | |
| | | | | | | | | plate | | | | |
| Battery 6 | 0.11 | Pb—Sn—Ca | 2 | Not | Pb—Sn—Ca | Pb—Sb | Bag | Negative | 75 | 9.3 | 0.52 | 3.0 |
| | | | | present | | | | electrode | | | | |
| | | | | | | | | plate | | | | |
| Battery 7 | 0.11 | Pb—Sn—Ca | 2.2 | Not | Pb—Sn—Ca | Pb—Sb | Bag | Negative | 75 | 9.5 | 1.8 | 3.0 |
| | | | | present | | | | electrode | | | | |
| | | | | | | | | plate | | | | |
| Battery 8 | 0.11 | Pb—Sn—Ca | 1.7 | Not | Pb—Sn—Ca | Not | Bag | Negative | 57 | 9.1 | 0 | 2.9 |
| | | | | present | | present | | electrode | | | | |
| | | | | | | | | plate | | | | |
| Battery 9 | 0.11 | Pb—Sn—Ca | 1.7 | Not | Pb—Sn—Ca | Pb—Sb | Bag | Positive | 56 | 9.1 | 0 | 2.5 |
| | | | | present | | | | electrode | | | | |
| | | | | | | | | plate | | | | |

As shown in Table 2, Batteries 2-6 in which the mass ratio of the upper half of the positive electrode grid to the lower half was A-B showed the SOC representing the characteristic in the “short-distance drive” mode of 70% or higher, the high output characteristic in low SOC, and a good yield of the positive electrode plate 2. The lead-acid storage batteries satisfying these requirements can restrain the actuation of the fail-safe mechanism even when the vehicle with the start-stop system is used in the “short-distance drive” mode. Further, even when the engine is stopped by the start-stop system when the lead-acid battery is in the low SOC, the battery can provide a sufficient output, and the engine can smoothly be restarted. Batteries 2-6 can be produced with high yields.

In particular, regarding Batteries 3-5 in which the Na content in the electrolytic solution was in the range of 1.6-1.8, the output characteristic in low SOC and the yield of the positive electrode plate 2 were both high. Thus, Batteries 3-5 allow efficient production of the lead-acid battery exclusive for the vehicle with the start-stop system, and are suitable for the vehicle with the start-stop system used in the “short-distance drive” mode.

In contrast, Battery 1 in which the mass ratio of the upper half of the positive electrode grid to the lower half was 1.5 showed poor output characteristic in low SOC. This is presumably because the output characteristic was remarkably reduced due to lack of optimization of a current path to the tabs 109 when the SOC was low (a conductive path around the tabs 109 where the current is concentrated is not thick).

Regarding Battery 8 in which the surface layer was not provided on the negative electrode grid, the SOC representing the characteristic in the “short-distance drive” mode was as significantly low as 57%. This is presumably because the hydrogen overvoltage was not reduced, and the charge acceptability was low due to the absence of the lead alloy foil containing Sb on the surface of the negative electrode grid.

Regarding Battery 9 in which the positive electrode plates were contained in the bag-shaped separators, the SOC representing the characteristic in the “short-distance drive” mode was as low as 56%. This is presumably because the negative electrode plates on both sides of the electrode group were not contained in the bag-shaped separators, and were pressed onto an inner wall of the cell chamber. Thus, the electrolytic solution did not sufficiently penetrate into the negative electrode plates facing the inner wall of the cell chamber, thereby reducing the charge acceptability.

From the above-described results, the lead-acid battery which is suitable for the vehicle with the start-stop system used in the “short-distance drive” mode, can smoothly restart the vehicle, and can restrain the actuation of the fail-safe mechanism can be provided with high yields by forming the surface layer made of a lead alloy containing antimony on the surface of the negative electrode grid free from antimony, arranging the negative electrode plates contained in the bag-shaped separators on both sides of the electrode group, and controlling the mass ratio of the upper half of the positive electrode grid to the lower half in a range of 1.55 or higher and 2.0 or lower, preferably 1.6 or higher and 1.8 or lower.

### Example 2

To evaluate the recoverability from the overdischarge, the Na ion content in the electrolytic solution in Battery 4 fabricated in Example 1 was varied in the range of 0.01-0.45 mol/L to fabricate Batteries 10-13, and the characteristic in the “short-distance drive” mode, and the recoverability from the overdischarge were evaluated on each of the batteries. The negative electrode plates were arranged on both sides of the electrode group, and were contained in the bag-shaped separators.

The negative electrode grid was an expanded grid including a negative electrode grid body made of Pb-1.2Sn-0.1Ca, and a surface layer made of Pb foil containing 3% by mass of Sb. The positive electrode grid was an expanded grid made of Pb-1.6Sn-0.1Ca, and did not include any surface layer. The mass ratio of the upper half of the positive electrode grid to the lower half was 1.7.

TABLE 3

| | | | | | | | | | “Short- | | | Duration |
|---|---|---|---|---|---|---|---|---|---|---|---|---|
| | | Positive electrode plate | | | | | | | distance | | | indicating |
| | | Positive electrode grid | | | | | | | ride” | | Defect | recover- |
| | | | Mass ratio | | Negative | | | | charac- | Output | ratio of | ability |
| | Na ion | | of upper | | electrode plate | | | | teristic | characteristic | positive | from over- |
| | content | | half/lower | Surface | | Surface | Separator | | SOC | in low SOC | electrode | discharge |
| | (mol/L) | Composition | half | layer | Composition | layer | Shape | Contains | (%) | (V) | plate (%) | (min) |
| Battery | 0.01 | Pb—Sn—Ca | 1.7 | Not | Pb—Sn—Ca | Pb—Sb | Bag | Negative | 73 | 9.1 | 0 | 2.5 |
| 10 | | | | present | | | | electrode | | | | |
| | | | | | | | | plate | | | | |
| Battery | 0.03 | Pb—Sn—Ca | 1.7 | Not | Pb—Sn—Ca | Pb—Sb | Bag | Negative | 74 | 9.1 | 0 | 2.9 |
| 11 | | | | present | | | | electrode | | | | |
| | | | | | | | | plate | | | | |
| Battery 4 | 0.11 | Pb—Sn—Ca | 1.7 | Not | Pb—Sn—Ca | Pb—Sb | Bag | Negative | 75 | 9.1 | 0 | 3.0 |
| | | | | present | | | | electrode | | | | |
| | | | | | | | | plate | | | | |
| Battery | 0.28 | Pb—Sn—Ca | 1.7 | Not | Pb—Sn—Ca | Pb—Sb | Bag | Negative | 74 | 9.1 | 0 | 3.0 |
| 13 | | | | present | | | | electrode | | | | |
| | | | | | | | | plate | | | | |
| Battery | 0.45 | Pb—Sn—Ca | 1.7 | Not | Pb—Sn—Ca | Pb—Sb | Bag | Negative | 70 | 9.1 | 0 | 3.0 |
| 14 | | | | present | | | | electrode | | | | |
| | | | | | | | | plate | | | | |

As shown in Table 3, Batteries 11-12 in which the Na ion content in the electrolytic solution was in the range of 0.03-0.28 mol/L showed good results, i.e., the SOC representing the characteristic in the “short-distance drive” mode was 74% or higher, and the duration representing the recoverability from the overdischarge was not shorter than 3.0 minutes. Thus, Batteries 11-12 shows performance suitable for using the vehicle with the start-stop system in the “short-distance drive” mode.

Regarding Battery 13 in which the Na ion content in the electrolytic solution was 0.45 mol/L, the SOC representing the characteristic in the “short-distance drive” mode was as slightly low as 70%. This is presumably because the Na ions in the electrolytic solution inhibited a charge reaction.

Regarding Battery 10 in which the Na ion content in the electrolytic solution was 0.01 mol/L, the duration representing the recoverability from the overdischarge was as slightly short as 2.5 minutes. This is presumably because the recoverability from the overdischarge was slightly reduced.

The above-described results indicate that the lead-acid battery which shows good recoverability from the over discharge, restrains the actuation of the fail-safe mechanism, and is suitable for the vehicle with the start-stop system used in the “short-distance drive” mode can be provided by containing 0.03-0.28 mol/L of the Na ions in the electrolytic solution.

The present disclosure has been described by way of preferable embodiments. The embodiments are not limitative, and can be modified in various ways.

### INDUSTRIAL APPLICABILITY

### <Part 1>

The lead-acid battery of the present disclosure is a long-life, highly productive lead-acid battery which allows a user to precisely tell when the battery needs replacing. The lead-acid battery of the present disclosure is industrially useful.

### <Part 2>

The present disclosure is useful for lead-acid storage batteries used in vehicles with a start-stop system.

### DESCRIPTION OF REFERENCE CHARACTERS

1 Upper frame
2 Meshed part
2a Strand
2b Cover layer
3 Lower frame
4 Electrode group
4a Positive electrode plate
4b Negative electrode plate
4c Separator
5 Battery box
5a Divider
5b Cell chamber
6 Strap
7 Connector
8 Lid
9 Plug
10 Sheet
11 Foil
12 Slit
13 Plain part
14 Continuous body
15 Active material paste
101 Lead-acid battery
102 Positive electrode plate
103 Negative electrode plate
104 Separator
105 Electrode group
106 Cell chamber
107 Positive electrode strap
108 Negative electrode strap
109 Tab
110 Tab
111 Connector
112 Positive electrode terminal
113 Negative electrode terminal
114 Lid

1. A lead-acid battery grid used for an electrode of a lead-acid battery, wherein
the lead-acid battery grid is made of a Pb alloy containing at least one of Sn or Ca, and includes an upper frame constituting an upper side of the lead-acid battery grid, a lower frame constituting a lower side of the lead-acid battery grid, and a meshed part being present between the upper frame and the lower frame and including intersecting strands,
a ratio Wu/W of a mass Wu of an upper half of the meshed part to a total mass W of the meshed part is 62.5% or higher and 67% or lower, and a cover layer containing a larger amount of Sn than the strands is formed on at least part of a surface of the strands, and
the cover layer is not formed on a surface of the lower frame.

2. The lead-acid battery grid of claim 1, wherein
a mass ratio of Sn to the cover layer is 0.2% or higher and 10.0% or lower.

3. The lead-acid battery grid of claim 2, wherein
the mass ratio of Sn to the cover layer is 3.0% or higher and 7.0% or lower.

4. The lead-acid battery grid of claim 1, wherein
the cover layer further contains Sb, and a mass ratio of Sb to the cover layer is 0.2% or higher and 10.0% or lower.

5. The lead-acid battery grid of claim 4, wherein
the mass ratio of Sb to the cover layer is 3.0% or higher and 7.0% or lower.

6. The lead-acid battery grid of claim 1, wherein
the lead-acid battery grid is fabricated by an expanding method.

7. A lead-acid battery using the lead-acid battery grid of claim 1 as a positive electrode grid.

8. A lead-acid battery, comprising:
electrode groups, each of which includes a plurality of positive electrode plates and a plurality of negative electrode plates stacked with separators interposed therebetween, and is contained in a cell chamber together with an electrolytic solution, wherein
each of the positive electrode plates includes a positive electrode grid made of antimony-free lead or an antimony-free lead alloy, and a positive electrode active material filling the positive electrode grid,
each of the negative electrode plates includes a negative electrode grid, and a negative electrode active material filling the negative electrode grid,
the negative electrode grid includes a negative electrode grid body made of antimony-free lead or an antimony-free lead alloy, and a surface layer which is formed on a surface of the negative electrode grid body, and is made of a lead alloy containing antimony, and
a mass ratio of an upper half of the positive electrode grid to a lower half of the positive electrode grid is 1.55 or higher and 2.0 or lower.

9. The lead-acid battery of claim 8, wherein
the electrolytic solution contains 0.03 mol/L or higher and 0.28 mol/L or lower of sodium ions.

10. The lead-acid battery of claim 8, wherein
the negative electrode plates are contained in the separators, each of which is bag-shaped, and are arranged on sides of the electrode group.
